(19) United States
(12) Patent Application Publication
(10) Pub. No.: US 2008/0207091 A1
(43) Pub. Date: Aug. 28, 2008

(54) Slurry Composition For Color Filter Polishing

(76) Inventors: Yu-Lung Jeng, Taipei City (TW); Jea-Ju Chu, Taipei (TW); Chang-Tai Lee, Taipei City (TW); Karl Hensen, Heppenheim (DE)

Correspondence Address: J C PATENTS, INC., 4 VENTURE, SUITE 250, IRVINE, CA, 92618, US

(21) Appl. No.: 11/915,733

(22) PCT Filed: Jun. 12, 2006
(86) PCT No.: PCT/IB06/01571

§ 371 Date: Nov. 27, 2007

(51) Int. Cl. B24B 29/02; C09K 3/14; C09G 1/02

(52) U.S. Cl. 451/37; 51/308; 51/309

(57) ABSTRACT

The invention provides a slurry composition for polishing color filters. The slurry composition at least includes an abrasive, a buffer solution and an additive. The abrasive is selected from the group consisting of alumina, ceria, magnesia, silica, titania, zirconia, cupric oxide, ferric oxide, zinc oxide and the mixture thereof. The buffer solution is used for adjusting pH to a desired range. The additive is used for stabilizing the polishing composition and also improving the polishing performance.

### BACKGROUND OF THE INVENTION

1. Field of Invention

The present invention relates to a polishing slurry. More particularly, the present invention relates to a slurry composition for color filter polishing.

2. Description of Related Art

Following the progress of display technologies, the conventional bulky cathode ray tube (CRT) displays are being gradually replaced by the flat panel displays. The thinner and lighter flat panel display devices not only provide excellent image quality, but also provide advantages such as excellent mobility, durability and energy saving. These flat panel display products include liquid crystal display (LCD), organic electro-luminescence display (OEL or OLED), polymer light emitting diode (PLED or LEP), field emission display (FED), and plasma display panel (PDP).

The trends of LCD display development are full color, large size, high resolution and low cost. For best image quality, the LCD device employs the color filter to present color image. The color filter affects the image properties, such as contrast, luminance and surface reflection of the display panels.

The color filter is a layer of color photoresist consisting of three colors i.e., red, green and blue arranged in a highly ordered pattern. The driver IC to provide the grey-scale light controls the backlight source, and the grey-scale light passes through the color filter to present red, green or blue light. The red, green or blue lights are further combined to form color images. Color filter is one of the major components for the TFT-LCD panel display. It is critical to improve the quality of color filter for image quality, throughput and cost considerations.

FIG. 1 schematically shows the structure of prior art color filter. In FIG. 1, the structure of the color filter is composed of a glass substrate 100, a black matrix 102, a color layer 104a-104c, an over-coat layer 106 and an ITO conductive film 108. The thickness of the glass substrate 100 is being reduced to about 0.63 mm or 0.55 mm for reducing the weight of large LCD panel. The black matrix 102 is used to isolate the three-color photoresist layers 104a-104c and is essential for enhancing the color contrast. In general, the black matrix 102 requires low reflection for better color performance. The material of the black matrix 102 can be chromium or resin.

Color filters can be produced by dye dispersion method, staining method, printing method or electrical coloring method. The dye dispersion method can provide excellent reliability, resolution and high-temperature resistance, and is thus widely used in the industry.

The color photoresist ink used in the dye dispersion method includes dye, dispersant, additive, coupling resin, reactive dilution agent as well as photoactive starting agent and solvent. The color photoresist ink for coloring the three true colors (red, green and blue) is generally base-developed negative photoresist. The main components of the color photoresist ink are dye compounds, including azo dye compounds phthalocyanine organic pigments and various heterocyclic compounds. Depending on the product function or the process consideration, various mixtures can be used.

The dye dispersion method of producing color filter includes formation of black matrix, RGB and ITO layers. Regarding the formation of black matrix, a low-reflective double-layered film of chromium oxide/chromium is sputtered over the glass substrate covered with a silicon oxynitride protective layer. The low-reflective film of chromium oxide/chromium is also called the metal black layer. Afterwards, a positive photoresist layer is spin-coated on the metal black layer. Using the mask with the pattern of black matrix, the photoresist layer is exposed to UV light and developed, and the metal black layer is etched to obtain the pattern of black matrix.

After the black matrix pattern is formed, the RGB process is followed. In the RGB process, the red, green and blue color photoresists are deposited to designated positions to form the RGB pattern. Firstly, the red (R) color photoresist is spin-coated and exposed to UV light (<248 nm) by using the mask with the R pattern. After exposure, a developing agent is used to remove the un-exposed portion to form the R pattern. Afterwards, post-baking over 200° C. is performed to make the R pattern more resistant. Following the similar procedure, the green (G) pattern and the blue (B) pattern are formed. Subsequently the ITO transparent electrode layer is deposited on the top of RGB layer, thus completing the manufacture of color filters.

For better optical property and visual effect, the surface of color filter needs to be planarized, using a chemical mechanical polishing (CMP) method. As shown in FIG. 2, after obtaining the R, G, B patterns, the black matrix (BM) is present between each pattern for isolation. Depending on different requirements, the peak heights of the R, G, and B patterns after polishing (i.e. R1, R2, B1, B2, G1, G2) are required to below 5000 angstroms, while the height differences of the bottom positions of the patterns after polishing (called R, G, B loss) are required to be less than 500 angstroms.

However, the chemical ingredients in CMP slurry may result in undesired property alteration of the dyes of the color photoresists during and after the CMP operation.

### SUMMARY OF THE INVENTION

The present invention provides a slurry composition for color filter polishing. The slurry composition reduces interactions between the slurry and the color filter materials including resin, dye and dispersant, so that the reliability and service life of color filter can be ensured. By using such slurry composition, the manufacture stability for color filter production can be improved, and thus increasing the production throughput.

As embodied and broadly described herein, the present invention provides a slurry composition for polishing color filter comprising at least an abrasive, a buffer solution and an additive. The abrasive is selected from the group consisting of alumina, ceria, magnesia, silica, titania, zirconia, cupric oxide, ferric oxide, zinc oxide and the mixtures thereof. The abrasive can be provided in calcined, colloidal or fumed forms.

The slurry composition has a primary particle size smaller than 1.0 micron, mostly 10 nm to 1.0 micron, and preferably 40 nm to 200 nm. The primary particle size distribution of the abrasive particles is mono-distribution. Alternatively, abrasives of two different primary particle sizes can be mixed in the slurry composition, meaning that the primary particle size distribution can be a bimodal distribution. The abrasive particles of the slurry composition have secondary particle sizes ranging from 100 nm to 10 microns, preferably 200 nm to 800 nm. The content of the abrasive in the slurry composition ranges from about 1 wt % to 45 wt %, preferably 2 wt % to 25 wt %.

The specific surface area of the abrasive in the slurry composition ranges from about 5-400 m²/g, preferably 20-200 m²/g, for minimizing the formation of scratches, dents or other defects during polishing.

The buffer solution is used for adjusting the pH values and also acts as the pH buffer. The buffer solution can be selected from the group consisting of inorganic acids, organic acids, inorganic bases, the mixtures thereof and the salts thereof. The content of the buffer solution in the slurry composition ranges from 2 wt % to 15 wt %. The choice of the buffer solution depends on the abrasive used in the slurry composition. The organic acids used as the buffer solution can be selected from the group consisting of glycin, formic acid, acetic acid, propionic acid, malic acid, citric acid, succinic acid and the mixtures thereof. If the organic acid is selected for the buffer solution, organic or inorganic salts containing sodium, potassium, calcium or iron can be further added.

The additive used for the slurry composition may include one or more surfactants. The surfactant can adjust the zeta potential for improving dispersion or particle suspension at a specific pH, and thus stabilize the slurry composition. The surfactant can be selected from the group consisting of polycarboxylic acids; alkali salts of polycarboxylic acids, and ammonium salts of polycarboxylic acids, aliphatic polymers and the mixtures thereof. The content of the surfactant in the slurry composition ranges from about 0.3 wt % to 1.0 wt %.

Depending on the abrasive used in the slurry composition, the additive can be selected from the group consisting of N-methyl pyrrolidone, methacrylamide, butyrolactone, N-vinyl pyrrolidone and the mixtures thereof. Alternatively, the additive can be selected from the group consisting of methacrylamide, N, N′-methylene bisacrylamine, polyethylene glycol dimethacrylate, methoxy polyethylene glycol monomethacrylate and the mixtures thereof. The additive can not only increase polishing rate, but also improve polishing quality.

The slurry composition of this invention is suitable for polishing color filter, and the slurry compositions of this invention provide higher polishing rates than the conventional polishing slurry.

The abrasive added to the slurry composition of this invention is able to remove color photoresist mildly during polishing, and thus avoid overpolishing and increase pattern reliability of color filter. Hence, the polished color filter layer has precise topography control and thus excellent color image property can be achieved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 schematically shows the structure of prior art color filter.

FIG. 2 schematically shows the structure of prior art color filter.

FIG. 3 is the SEM photograph of the unpolished color filter sample.

FIG. 4 is the SEM photograph of the color filter sample polished by the polishing slurry of this invention.

FIG. 5 is the SEM photograph of the color filter sample polished by the commercially available alumina polishing slurry.

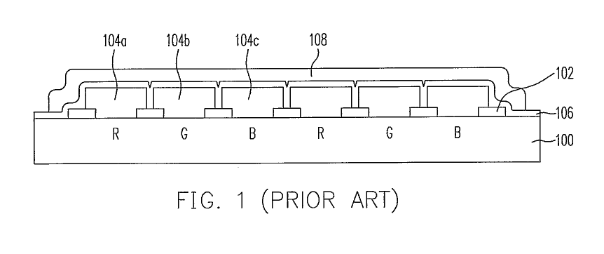

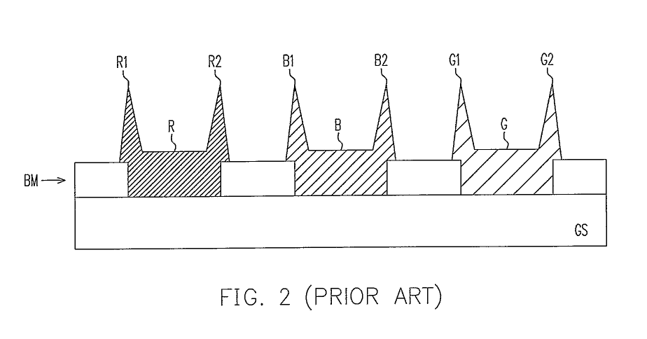

### DESCRIPTION OF THE PREFERRED EMBODIMENTS

The slurry composition of the present invention for polishing color filter refers to chemical agents for assisting the polishing of color filter. The slurry composition of the present invention can be used alone, or in combination with other polishing slurries for polishing color filter.

The present invention provides a slurry composition for polishing color filter comprising one or more abrasives. The abrasive is selected from the group consisting of alumina, ceria, magnesia, silica, titania, zirconia, cupric oxide, ferric oxide, zinc oxide and the mixtures thereof. The abrasive can be provided in colloidal or fumed forms. The content of the abrasive in the slurry composition ranges from about 1 wt % to 45 wt %, preferably 2 wt % to 25 wt %.

The abrasive is preferably of high purity. “High purity” means that the total impurity (such as the impurity in raw materials or from the treatments) content of the source is less than 100 ppm. The purpose is to reduce potential contamination from the slurry composition toward the color filter materials.

The abrasive is preferably mixed with hydrophilic or aqueous media (such as de-ionized water) to prepare aqueous solution by using a high-shear dispersion technique. For example, the abrasive can be added slowly to the suitable medium to form a colloidal solution. The colloidal solution is mixed under a high-shear condition and becomes stable by adjusting the pH of colloidal solution.

The slurry composition of this invention includes at least a stabilizer. The stabilizer can stabilize the surface charge of the abrasive particles in the slurry under acidic condition, inhibit the formation of large particle aggregates, and thus extend long-term stability of the slurry composition.

The slurry composition of this invention includes at least a buffer solution for adjusting the pH value and serving as the pH buffer. The buffer solution can be selected from the group consisting of inorganic acids, organic acids, inorganic bases, the mixtures thereof and the salts thereof. The choice of the buffer solution depends on the abrasive used in the slurry composition. The organic acids used as the buffer solution can be selected from the group consisting of glycine, formic acid, acetic acid, propionic acid, malic acid, citric acid, succinic acid and the mixtures thereof. If the organic acid is selected for the buffer solution, organic or inorganic salts containing sodium, potassium, calcium or iron can be further added. The content of the buffer solution in the slurry composition ranges from 2 wt % to 15 wt %. In addition, the pH of the slurry composition is preferably adjusted to a range between 5 and 7 using the buffer solution.

The additive used for the slurry composition may include one or more surfactants. Depending on the abrasive used in the slurry composition, the surfactant can be selected from the group consisting of alkali salts or ammonium salts of poly carboxylic acids, aliphatic polymers and the mixtures thereof. The content of the surfactant in the slurry composition ranges from about 0.3 wt % to 1.0 wt %. The molecular weight of the aliphatic polymer is between 1000 and 5000 Dalton, for example.

The additive used for the slurry composition can also be selected from the group consisting of N-methyl pyrrolidone, methacrylamide, butyrolactone, N-vinyl pyrrolidone and the mixtures thereof. Alternatively, the additive can be selected from the group consisting of methacrylamide, N,N′-methylene bisacrylamine, polyethylene glycol dimethacrylate, methoxy polyethylene glycol monomethacrylate and the mixtures thereof.

The slurry composition of this invention or the composition containing the slurry composition of this invention can be provided to the polishing pad of the polishing platform. The color filter is polished due to the relative motion between the polishing pad and the color filter substrate. Between the surface of the polishing pad and the color filter substrate, the polishing slurry is continuously provided during polishing.

The slurry composition of this invention employs one or more specific abrasives that have no chemical interaction with the color photoresist during the polishing process. Therefore, over-polishing or over-etching of the patterns can be avoided. Especially by using the slurry compositions of this invention, the produced color filter provides better pattern fidelity. The following examples 1-17 are used to further describe the details of this invention. However, these examples are not used to limit the scope of this invention. The slurry compositions including the abrasives, the buffer solution and the additives used in examples 1-17 are listed in Table 1, while the related physical properties and experimental data, including particle sizes and polishing rates are listed in Table 2. In examples 1-17, the prepared slurry compositions are used to polish color filter photoresists.

At first, the peak heights for the three-color photoresists red (R), green (G) and blue (B) are measured and noted. After polishing, they are measured again to determine the polishing effect of the polishing slurries. Under the prerequisite of RGB loss lower than 500° A, the polishing rates of the polishing slurries are investigated.

The experimental conditions are as follows:

Down force of the polishing platform: 0.08 psi or 0.05 psi

Rotation speed of the polishing platform: 20 rpm

Polishing time: 20 seconds

Polishing slurry flow rate: 120 ml/min

The thickness difference of color photoresist between before and after polishing is divided by the polishing time to obtain the polishing rate. The thickness of the color photoresist is measured by KLA Tencor P15 surface profiler. In Tables 1 and 2, Δh_{R}/Δh_{G}/Δh_{B} represents the average removal amount of the color photoresists in red, green and blue respectively.

TABLE 1

| | Abrasive | | Buffer Solution | | Additive | |
|---|---|---|---|---|---|---|
| | | Content | | Content | | Content |
| Examples | Name | (wt %) | Name | (wt %) | Name | (wt %) |
| 1 | polycrystalline | 20 | organic acids | <1 | — | — |
| | alumina | | potassium nitrate, | <5 | | |
| | | | potassium iodide | | | |
| | | | or potassium | | | |
| | | | carbonate | | | |
| 2 | polycrystalline | 10 | organic acids | <1 | — | — |
| | alumina | | potassium nitrate, | <5 | | |
| | | | potassium iodide | | | |
| | | | or potassium | | | |
| | | | carbonate | | | |
| 3 | polycrystalline | 10 | organic acids | <1 | Surfactant AG | 1 |
| | alumina | | potassium nitrate, | <5 | (product name) | |
| | | | potassium iodide | | | |
| | | | or potassium | | | |
| | | | carbonate | | | |
| 4 | polycrystalline | 10 | organic acids | <1 | SPS-1100B | 1 |
| | alumina | | potassium nitrate, | <5 | (product name) | |
| | | | potassium iodide | | | |
| | | | or potassium | | | |
| | | | carbonate | | | |
| 5 | polycrystalline | 10 | organic acids | <1 | | |
| | alumina | | potassium nitrate, | <5 | | |
| | | | potassium iodide | | | |
| | | | or potassium | | | |
| | | | carbonate | | | |
| 6 | polycrystalline | 20 | organic acids | <1 | | |
| | alumina | | potassium nitrate, | <5 | | |
| | | | potassium iodide | | | |
| | | | or potassium | | | |
| | | | carbonate | | | |
| 7 | polycrystalline | 20 | organic acids | <1 | N-N-methyl | 3 |
| | alumina | | potassium nitrate, | <5 | pyrrolidone | |
| | | | potassium iodide | | | |
| | | | or potassium | | | |
| | | | carbonate | | | |
| 8 | polycrystalline | 20 | organic acids | <1 | N-N-methyl | 5 |
| | alumina | | potassium nitrate, | <5 | pyrrolidone | |
| | | | potassium iodide | | | |
| | | | or potassium | | | |
| | | | carbonate | | | |
| 9 | polycrystalline | 20 | organic acids | <1 | Butyrolactonol | 3 |
| | alumina | | potassium nitrate, | <5 | | |
| | | | potassium iodide | | | |
| | | | or potassium | | | |
| | | | carbonate | | | |
| 10 | polycrystalline | 20 | organic acids | <1 | Butyrolactonol | 5 |
| | alumina | | potassium nitrate, | <5 | | |
| | | | potassium iodide | | | |
| | | | or potassium | | | |
| | | | carbonate | | | |
| 11 | Calcined | 20 | organic acids | <1 | | |
| | alumina | | potassium nitrate, | <5 | | |
| | | | potassium iodide | | | |
| | | | or potassium | | | |
| | | | carbonate | | | |
| 12 | Calcined | 20 | organic acids | <1 | | |
| | alumina | | potassium nitrate, | <5 | | |
| | | | potassium iodide | | | |
| | | | or potassium | | | |
| | | | carbonate | | | |
| 13 | Calcined | 20 | organic acids | <1 | — | — |
| | alumina | | potassium nitrate, | <5 | | |
| | | | potassium iodide | | | |
| | | | or potassium | | | |
| | | | carbonate | | | |
| 14 | Fumed | 20 | — | — | — | — |
| | alumina | | | | | |
| 15 | Precipitated | 5 | — | — | — | — |
| | ceria | | | | | |
| 16 | Colloidal | 20 | KOH | <1 | — | — |
| | silica | | | | | |
| 17 | Fumed silica | 12.1 | HCl, KOH | <1 | MA-21(Product | 0.5 |
| | | | | | name) | |

TABLE 2

| | | Primary | Secondary | | | | |
|---|---|---|---|---|---|---|---|
| | | particle | particle | Average polishing rate | | | |
| | | size | size | Δh_{R} | Δh_{G} | Δh_{B} | Down |
| Examples | pH | (nm) | (nm) | Å/20 sec | Å/20 sec | Å/20 sec | force (psi) |
| 1 | 6.0 | ~20/50 | ~200 | 1274 | 1602 | 1699 | 0.08 |
| 2 | 6.0 | ~20/50 | ~200 | 1391 | 1388 | 1828 | 0.08 |
| 3 | 6.0 | ~20/50 | ~200 | 2453 | 3976 | 2178 | 0.08 |
| 4 | 6.0 | ~20/50 | ~200 | 814 | 2691 | 984 | 0.08 |
| 5 | 6.0 | ~20/50 | ~200 | 891 | 1137 | 1156 | 0.05 |
| 6 | 6.0 | ~20/50 | ~200 | 1031 | 1309 | 1393 | 0.05 |
| 7 | 6.0 | ~20/50 | ~200 | 1535 | 1625 | 1619 | 0.05 |
| 8 | 6.0 | ~20/50 | ~200 | 1447 | 1920 | 1409 | 0.05 |
| 9 | 6.0 | ~20/50 | ~200 | 1742 | 2273 | 1487 | 0.05 |
| 10 | 6.0 | ~20/50 | ~200 | 1586 | 2040 | 1471 | 0.05 |
| 11 | 6.0 | ~50 | 195 | 1080 | 1384 | 918 | 0.05 |
| 12 | 6.0 | ~70 | 314 | 3397 | 3744 | 3181 | 0.05 |
| 13 | 4.1 | ~50 | 224 | 1631 | 1749 | 1479 | 0.05 |
| 14 | 4.4 | ~13 | 156 | 107 | 396 | 129 | 0.05 |
| 15 | 4.3 | ~20 | 173 | 258 | 404 | 118 | 0.05 |
| 16 | 9.6 | ~60 | 97 | 146 | 348 | 111 | 0.05 |
| 17 | 11.1 | ~20 | ~120 | 1380 | 1960 | 1561 | 0.05 |

### EXAMPLE 1

As shown in Table 1 and Table 2, in Example 1, 20 wt % polycrystalline alumina is used as the abrasive for the polishing slurry; under the down force of 0.08 psi, the average polishing rates (Δh_{R}/Δh_{G}/Δh_{B}, the removal amount in 20 seconds) of the polishing slurry are excellent.

### EXAMPLE 2

As shown in Table 1 and Table 2, in Example 2, 10 wt % polycrystalline alumina is used as the abrasive for the polishing slurry; under the down force of 0.08 psi, the average polishing rates (Δh_{R}/Δh_{G}/Δh_{B}, the removal amount in 20 seconds) of the polishing slurry are lower than that in Example 1, but satisfactory for color filter manufacturing.

### EXAMPLE 3

As shown in Table 1 and Table 2, in Example 3, 5 wt % Surfactant AG (Merck EC) is added as the surfactant and 10 wt % polycrystalline alumina is used as the abrasive for the polishing slurry; under the down force of 0.08 psi, the average polishing rates (Δh_{R}/Δh_{G}/Δh_{B}, the removal amount in 20 seconds) are increased significantly due to the addition of the surfactant. The addition of surfactant can increase the polishing rate.

### EXAMPLE 4

As shown in Table 1 and Table 2, in Example 4, 5 wt % SPS-1100B (Merck EC) is added as the surfactant and 10 wt % polycrystalline alumina is used as the abrasive for the polishing slurry. Under the down force of 0.08 psi, for the average polishing rates (Δh_{R}/Δh_{G}/Δh_{B}, the removal amount in 20 seconds) of the three colors red (R), green (G) and blue (B), the average polishing rate Δh_{G} increases significantly while the average polishing rates of the other two colors are decreased. Hence, the surfactant has different impacts on various color photoresist materials.

### EXAMPLE 5˜6

As shown in Table 1 and Table 2, 10 wt % and 20 wt % polycrystalline alumina is used respectively as the abrasive for the polishing slurry in Examples 5 and 6 (the same composition as Example 2 and 1 respectively). Under the down force of 0.05 psi, the average polishing rates (Δh_{R}/Δh_{G}/Δh_{B}, the removal amount in 20 seconds) for the two compositions are excellent.

### EXAMPLE 7˜8

As shown in Table 1 and Table 2, in Example 7, 20 wt % polycrystalline alumina is used as the abrasive for the polishing slurry and 3 wt % N-methylpyrrolidone is added to the slurry. Under the down force of 0.05 psi, the average polishing rates (Δh_{R}/Δh_{G}/Δh_{B} the removal amount in 20 seconds) are pretty high and the average polishing rates for three colors are similar. In Example 8, by adding 5 wt % N-N-methylpyrrolidone, the average polishing rate Δh_{G} is significantly increased, while the average polishing rates Δh_{R} and Δh_{B} are decreased. Hence, the differences between the average polishing rates of three colors become larger. Accordingly, the addition amount of the surfactant needs to be precisely controlled.

### EXAMPLE 9˜10

As shown in Table 1 and Table 2, in Example 9, 20 wt % polycrystalline alumina is used as the abrasive for the polishing slurry and 3 wt % butyrolactonol is added to the slurry. Under the down force of 0.05 psi, the average polishing rates (Δh_{R}/Δh_{G}/Δh_{B}, the removal amount in 20 seconds) are pretty high. However, the average polishing rates of three colors are dissimilar. In Example 10, by adding 5 wt % butyrolactonol, the average polishing rates are decreased. Therefore, the addition amount of the surfactant needs to be precisely controlled.

### EXAMPLE 11˜13

As shown in Table 1 and Table 2, in Example 11˜13, 20 wt % calcined alumina is used as the abrasive for the polishing slurry; calcined alumina is a mono-crystalline alumina. The primary particle size and secondary particle size of calcined alumina in Examples 11 and 12 are evidently different. The larger particle sizes in Example 12 result in high polishing rates. When compared with Example 11, the lower pH value and the larger secondary particle size in Example 13 give higher polishing rates. For the slurry using alumina as the abrasive, due to the differences in particle size, e shape or crystal phases, calcined alumina has higher polishing rate than polycrystalline alumina or fumed alumina.

### EXAMPLE 14

As shown in Table 1 and Table 2, in Example 14, 20 wt % fumed alumina is used as the abrasive for the polishing slurry. The major components of fumed alumina include amorphous alumina and partially crystalline alumina. Fumed alumina has very small primary particle size and hardness lower than a-phase polycrystalline alumina and calcined alumina, thus providing weaker cutting capability. In Example 14, fumed alumina is dispersed in de-ionized water and formulated into polishing slurry. The polishing tests show lower polishing rates.

### EXAMPLE 15

As shown in Table 1 and Table 2, in Example 15, 5 wt % ceria is used as the abrasive for the polishing slurry. Herein, the ceria particle is synthesized by a hydrothermal process, having particles with a small primary size in spherical shape. Ceria has the hardness equivalent to that of silica and but has a high activity for polishing. Though the solid content used being only 5 wt % ceria, the polishing rate herein is higher than that by using 20 wt % fumed alumina (in Example 14) or colloidal alumina (in Example 16).

### EXAMPLE 16

As shown in Table 1 and Table 2, in Example 16, 20 wt % colloidal silica is used as the abrasive for the polishing slurry. The major components of colloidal silica include amorphous silica and pH buffer solution. Colloidal silica has a larger primary particle size and smaller secondary particle size, due to the excellent dispersion of particles, thus adversely affecting its cutting capability. The results show rather low polishing rates.

### EXAMPLE 17

As shown in Table 1 and Table 2, in Example 17, 12.1 wt % fumed silica is used as the abrasive for the chemical mechanical polishing slurry for the dielectric layer. The major components of fumed silica include amorphous silica. Fumed silica has primary particle sizes of about 20 nm and larger secondary particle sizes resulting from the formation of dense agglomerates. With higher pHs, the results show rather good polishing rates.

### Comparison of Polishing Characteristics

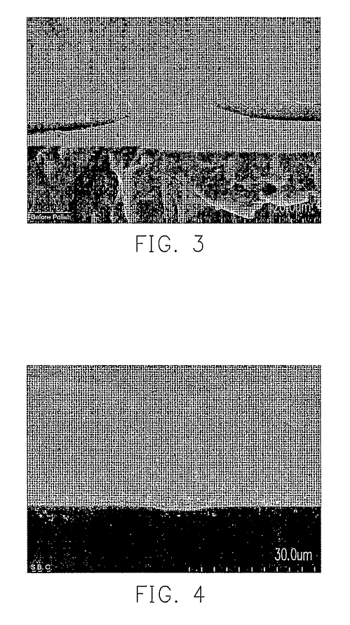

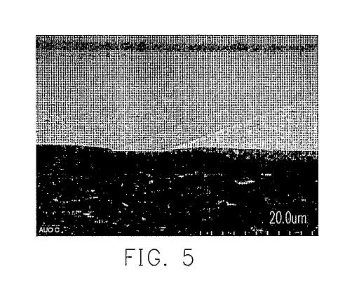

A commercially available alumina polishing slurry and the polishing slurry of this invention are used to polish the color filter samples. The SEM photograph of the unpolished color filter sample is shown in FIG. 3. The SEM photograph of the color filter sample polished by the polishing slurry of this invention is shown in FIG. 4. The SEM photograph of the color filter sample polished by the commercially available alumina polishing slurry is shown in FIG. 5. The color filter sample polished by the polishing slurry of this invention shows a better planarization result than that polished by the commercially available alumina polishing slurry. Moreover, the polishing slurry of this invention provides a polishing rate at least 10% higher than that of the commercially available alumina polishing slurry.

From the experimental results, the slurry composition for color filters provided in this invention can prevent over-polishing and the undesired etching problems.

The slurry composition for color filter polishing provided in this invention is stable and can stay effective for a long period. By suing such composition, the pattern reliability of the polished color filters is superior and the production throughput and yield can be further improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A polishing slurry composition for color filters, comprising:
at least an abrasive, wherein the abrasive is selected from the group consisting of alumina, ceria, magnesia, silica, titania, zirconia, cupric oxide, ferric oxide, zinc oxide and mixtures thereof;
a buffer solution for adjusting a pH value of the composition; and
an additive, for calibrating a zeta potential of particles of the abrasive in the composition under the pH value,
wherein the polishing slurry composition does not comprise an oxidizing agent.

2. The composition of claim 1, wherein the abrasive is in a fumed form or a colloidal form.

3. The composition of claim 1, wherein silica is calcined silica.

4. The composition of claim 1, wherein primary particle sizes of the particles range from 10 nm to 1.0 micron.

5. The composition of claim 1, wherein primary particle sizes of the particles range from 40 nm to 200 nm.

6. The composition of claim 1, wherein secondary particle sizes of the particles range from 100 nm to 10 microns.

7. The composition of claim 1, wherein secondary particle sizes of the particles range from 200 nm to 800 nm.

8. The composition of claim 1, wherein a primary particle size distribution of the particles is mono-distribution.

9. The composition of claim 1, wherein a primary particle size distribution of the particles is bimodal distribution.

10. (canceled)

11. The composition of claim 1, wherein a content of the abrasive in the polishing slurry composition ranges from about 2% to 25 wt %.

12. The composition of claim 1, wherein the pH value of the polishing slurry composition ranges from 2 to 8.

13. The composition of claim 1, wherein the pH value of the polishing slurry composition ranges from 5 to 7.

14. The composition of claim 1, wherein the buffer solution is selected from the group consisting of inorganic acids, organic acids, inorganic bases, mixtures thereof and salts thereof.

15. The composition of claim 14, wherein the organic acids are selected from the group consisting of glycin, formic acid, acetic acid, propionic acid, malic acid, citric acid, succinic acid and mixtures thereof.

16. (canceled)

17. The composition of claim 1, wherein the additive includes a surfactant.

18. The composition of claim 17, wherein a content of the surfactant in the polishing slurry composition ranges from about 0.3 wt % to 1.0 wt %.

19. The composition of claim 1, wherein the surfactant is selected from the group consisting of alkali salts of poly carboxylic acids, ammonium salts of poly carboxylic acids, aliphatic polymers and mixtures thereof.

20. The composition of claim 19, wherein a molecular weight of the aliphatic polymers is about 1000-5000 Daltons.

21. The composition of claim 1, wherein the additive is selected from the group consisting of N-methyl pyrrolidone, methacrylamide, butyrolactone, N-vinyl pyrrolidone, N,N′-methylene bisacrylamine, polyethylene glycol dimethacrylate, methoxy polyethylene glycol monomethacrylate and mixtures thereof.

22. A polishing slurry composition for color filters, consisting of:
at least an abrasive, wherein the abrasive is selected from the group consisting of alumina, ceria, magnesia, silica, titania, zirconia, cupric oxide, ferric oxide, zinc oxide and mixtures thereof;
a buffer solution for adjusting a pH value of the composition; and
an additive, for calibrating a zeta potential of particles of the abrasive in the composition under the pH value.

23. A method for polishing color filters, comprising:
providing a slurry composition to a polishing pad of a polishing platform, the slurry composition comprising:
at least an abrasive, wherein the abrasive is selected from the group consisting of alumina, ceria, magnesia, silica, titania, zirconia, cupric oxide, ferric oxide, zinc oxide and mixtures thereof;
a buffer solution for adjusting a pH value of the composition; and
an additive, for calibrating a zeta potential of particles of the abrasive in the composition under the pH value;
polishing the color filter by providing relative motion between the polishing pad and a color filter substrate to planarize the color filter substrate; and
continuously providing the slurry composition between the surface of the polishing pad and the color filter substrate.
